(19) United States
(12) Patent Application Publication
(10) Pub. No.: US 2015/0109400 A1
(43) Pub. Date: Apr. 23, 2015

(54) Method, Apparatus and System for Controlling Multipicture Display

(71) Applicant: Huawei Technologies Co., Ltd., Shenzhen (CN)

(72) Inventor: Dongqi Wang, Shenzhen (CN)

(21) Appl. No.: 14/560,648

(22) Filed: Dec. 4, 2014

Related U.S. Application Data
(63) Continuation of application No. PCT/CN2013/073713, filed on Apr. 3, 2013.

(30) Foreign Application Priority Data
Jun. 5, 2012 (CN) 201210182098.8

(51) Int. Cl. G06F 3/0484; G06F 3/0486; H04N 7/15

(52) U.S. Cl. CPC G06F 3/04845; H04N 7/15; G06F 3/04847; G06F 3/0486
USPC 348/14.03

(57) ABSTRACT

A method, an apparatus, and a system for controlling multipicture display. The method includes receiving a sliding track of a user operation, and performing an operation on a multipicture division line according to the sliding track of the user operation; and controlling picture display on a target screen according to a multipicture display mode formed using the multipicture division line that is obtained after the operation. The method, apparatus, and system for controlling multipicture display according to the embodiments of the present invention can implement visual and flexible setting of a multipicture display mode.

### CROSS-REFERENCE TO RELATED APPLICATIONS

This application is a continuation of International Application No. PCT/CN2013/073713, filed on Apr. 3, 2013, which claims priority to Chinese Patent Application No. 201210182098.8, filed on Jun. 5, 2012, both of which are hereby incorporated by reference in their entireties.

### TECHNICAL FIELD

The present invention relates to information processing technologies, and in particular, to a method, an apparatus, and a system for controlling multipicture display, which belongs to the communications technology field.

### BACKGROUND

As a telepresence system develops, a growing number of enterprises choose the telepresence system to establish a video conference system. As for the so-called telepresence system, the system displays a life-size image, a person on a screen and a user in a conference site can perform eye-to-eye communication, and the system can perform image stitching for a received image, and can implement features such as voice localization. In addition, for convenience of a user operation, a control device with a touchscreen is generally provided, so that it is convenient for a user to control a conference. In a multipoint conference with a plurality of participants, a participant may expect to watch images of more conference sites in some periods of time. This may be implemented by means of a method for presenting multiple conference site images on one screen, that is, a multipicture manner. FIGS. 1A-1C is a schematic diagram of a multipicture display mode in the prior art. As shown in FIGS. 1A-1C, a common multipicture display mode, for example, including four pictures FIG. 1A, six pictures in FIG. 1B, nine pictures in FIG. 1C, or the like, is used to enable a user to watch pictures of four, six, or nine conference sites.

FIG. 1D is a schematic diagram of a networking structure of a video conference system in the prior art. A networking architecture of a general video conference system is shown in FIG. 1D, where three conference sites are included. For exemplary purposes, each conference site has one conference terminal, and three conference sites perform communication using a communications network and a multipoint control server (a device used for media control and distribution). A conference site 1 shown in FIG. 1D is used as an example. When a participant or a conference administrator in the conference site 1 needs to perform setting or switching on the multipicture display mode, for example, the multipicture display mode is switched from four pictures to six pictures, the participant or the configuration administrator in the conference site 1 needs to call up a display mode selection menu provided on the screen, set the multipicture display mode of the display to six pictures in the display mode selection menu, and click an OK button to trigger adjusting of the multipicture display mode. A manner of sending a message is used to notify the multipoint control server (as an example, the multipoint control server is called multipoint control unit (MCU) during a specific product implementation). The MCU combines video sources of conference sites corresponding to a multipicture into one multipicture video according to a set multipicture display mode and sends the multipicture video to a corresponding conference site. After receiving the multipicture video, the corresponding conference site decodes multipicture video, and displays the multipicture video on a corresponding screen.

It may be seen that when the foregoing manner is used for multipicture display mode setting, a participant or a conference administrator can select one mode from the preset several multipicture display modes only using a manner of browsing a list, which makes it impossible to implement visual and flexible setting of the multipicture display mode.

### SUMMARY

Based on existing technical problems in the prior art, embodiments of the present invention provide a method, an apparatus, and a system for controlling multipicture display, so as to implement visual and flexible setting of a multipicture display mode.

According to one aspect, an embodiment of the present invention provides a method for controlling multipicture display, including receiving a sliding track of a user operation, and performing an operation on a multipicture division line according to the sliding track of the user operation; and controlling picture display on a target screen according to a multipicture display mode formed using the multipicture division line that is obtained after the operation.

According to another aspect, an embodiment of the present invention provides an apparatus for controlling multipicture display, including a display, a first processor, and a second processor, where the first processor is separately connected to the display and the second processor; where the display is configured to receive a sliding track of a user operation and send the sliding track of the user operation to the first processor; the first processor is configured to perform an operation on a multipicture division line according to the sliding track of the user operation and send a multipicture division line that is obtained after the operation to the second processor; and the second processor is configured to control picture display on a target screen according to a multipicture display mode formed using the multipicture division line that is obtained after the operation.

According to yet another aspect, an embodiment of the present invention provides a system for controlling multipicture display, including a target screen, and a multipicture display control apparatus provided by the embodiments of the present invention.

According to the method, apparatus, and system for controlling multipicture display provided by the embodiments of the present invention, because a user can perform an operation such as clicking and dragging on a multipicture division line in a multipicture display mode, a multipicture display mode formed according to an adjusted multipicture division line is obtained, which implements visual and flexible setting of a multipicture display mode.

### BRIEF DESCRIPTION OF DRAWINGS

To describe the technical solutions in the embodiments of the present invention or in the prior art more clearly, the following briefly introduces the accompanying drawings required for describing the embodiments or the prior art. The accompanying drawings in the following description show merely some embodiments of the present invention, and a person of ordinary skill in the art may still derive other drawings from these accompanying drawings without creative efforts.

FIGS. 1A-1C are schematic diagrams of a multipicture display mode in the prior art;

FIG. 1D is a schematic diagram of a networking structure of a video conference system in the prior art;

FIG. 2 is an architecture diagram of a typical video conference system;

FIGS. 3A-3B are schematic diagrams of a control interface of a control device;

FIGS. 4A-4B are schematic diagrams of a display area of a control device;

FIG. 5 is a schematic flowchart of a method for controlling multipicture display according to Embodiment 1 of the present invention;

FIGS. 6A-6B are schematic diagrams of generating a multipicture division line;

FIG. 7 is a schematic diagram of moving a multipicture division line;

FIG. 8 is a first schematic diagram of selecting a multipicture division line;

FIG. 9 is a second schematic diagram of selecting a multipicture division line;

FIG. 10 is a first schematic diagram of rotating a multipicture division line;

FIGS. 11A-11B are first schematic diagrams of setting a multipicture display mode according to multipicture division line generation information;

FIGS. 12A-12B are second schematic diagrams of setting a multipicture display mode according to multipicture division line generation information;

FIGS. 13A-13B are first schematic diagrams of setting a multipicture display mode according to multipicture division line deletion information;

FIGS. 14A-14C are first schematic diagrams of setting a multipicture display mode according to multipicture division line movement information;

FIGS. 15A-15C are second schematic diagrams of setting a multipicture display mode according to multipicture division line movement information;

FIGS. 16A-16D are first schematic diagrams of setting a multipicture display mode according to multipicture division line rotation information;

FIGS. 17A-17C are second schematic diagrams of rotating a multipicture division line;

FIGS. 18A-18D are third schematic diagrams of setting a multipicture display mode according to multipicture division line generation information;

FIGS. 19A-19D are second schematic diagrams of setting a multipicture display mode according to multipicture division line deletion information;

FIGS. 20A-20D are schematic diagrams of setting a multipicture display mode according to multiple pieces of multipicture division line operation information;

FIGS. 21A-21F are schematic diagrams of multipicture display modes stored in a database;

FIGS. 22A-22B are schematic diagrams of selecting a second multipicture display mode according to a first multipicture display mode;

FIG. 23 is a schematic structural diagram of an apparatus for controlling multipicture display according to Embodiment 7 of the present invention;

FIG. 24 is a schematic structural diagram of an apparatus for controlling multipicture display according to another embodiment of the present invention;

FIG. 25 is a schematic structural diagram of an apparatus for controlling multipicture display according to still another embodiment of the present invention;

FIG. 26 is a schematic structural diagram of an apparatus for controlling multipicture display according to yet another embodiment of the present invention;

FIG. 27 is a schematic structural diagram of an apparatus for controlling multipicture display according to yet another embodiment of the present invention; and

FIG. 28 is a schematic structural diagram of an apparatus for controlling multipicture display according to yet another embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

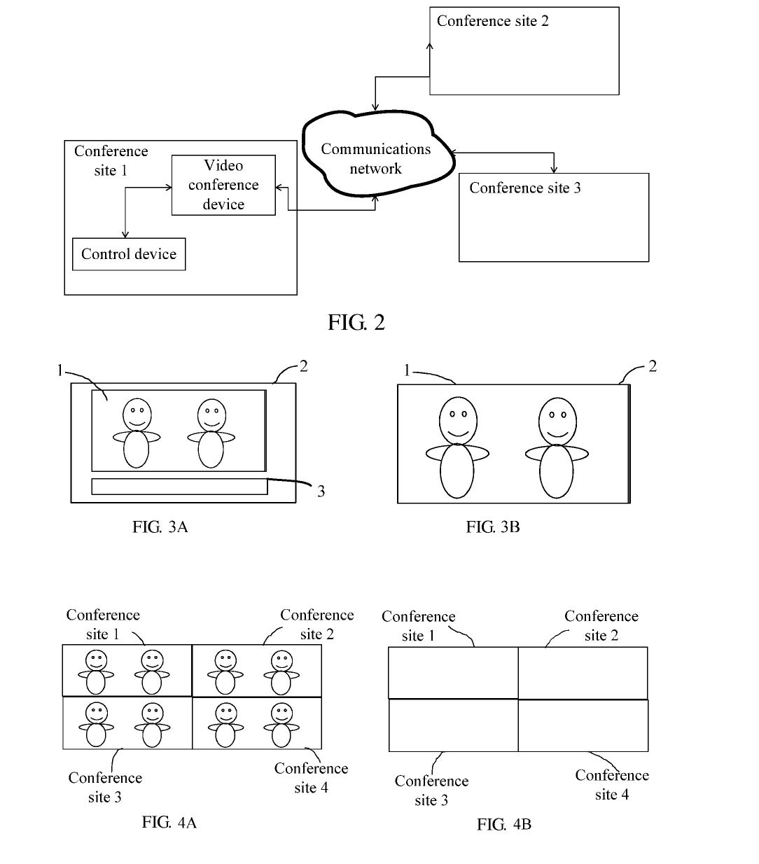

FIG. 2 is an architecture diagram of a typical video conference system. As shown in FIG. 2, the video conference system includes two or more conference sites, and each conference site is disposed with a video conference device, where the video conference device includes a terminal device, a display device, a microphone, a loudspeaker, and the like. In addition, each conference is further equipped with a control device, and the control device can control the video conference device and a conference process at the conference site, for example, switching on/off the video conference device, or holding/ending a conference, or the like.

FIGS. 3A-3B are schematic diagrams of a control interface of a control device. As shown in FIGS. 3A-3B, a display of an entire control device includes a display area 1 and a control area 2, and further optionally includes an auxiliary area 3. FIGS. 4A-4B are schematic diagrams of a display area of a control device. As shown in FIGS. 4A-4B, the display area corresponds to a controlled screen, and the controlled screen may display, in real time, a live video activity image (as shown in FIG. 4A), or may not display a video state but only present a border of each sub-picture of a multipicture, that is, multipicture division lines (as shown in FIG. 4B). The control area is used by a user to perform an operation such as configuration of a multipicture display mode. When the control interface includes an auxiliary area, the control area includes a display area and an auxiliary area (as shown in FIG. 3A); and when the control interface does not include an auxiliary area, the control area is equivalent to the display area (as shown in FIG. 3B). The auxiliary area is used to display conference site information of each conference site in the conference, for example, a conference site name, or a thumbnail image of a conference site, or the like is included. The auxiliary area may be hidden in a period of time. Then, in this case, the control interface of the control device is as shown in FIG. 3B.

### Embodiment 1

The method for controlling multipicture display according to Embodiment 1 of the present invention may be executed by the control device shown in FIG. 2. FIG. 5 is a schematic flowchart of a method for controlling multipicture display according to Embodiment 1 of the present invention. As shown in FIG. 5, the method includes the following steps:

Step S101: Receive a sliding track of a user operation, and perform an operation on a multipicture division line according to the sliding track of the user operation.

Step S102: Control picture display on a target screen according to a multipicture display mode formed using the multipicture division line that is obtained after the operation.

In a video conference system, a screen of a conference site may display a conference site image according to a single-picture display mode or a multipicture display mode. In the single-picture display mode, the screen does not include a division line. In the multipicture display mode, division between multiple pictures is implemented by setting a multipicture division line between any two pictures.

A user performs an operation on a control area of the control device. A control port of the control device converts a user operation into operation information that can be executed by a device (that is, operation information on a multipicture division line), and according to the operation information on the multipicture division line, performs adjusting on a multipicture division line of a border line of a display area. The adjusting, for example, includes addition, deletion, movement, and/or rotation, and the like, so that adjusting of a multipicture display mode is implemented. The user operation may be any operation, for example, including, a touching (clicking) operation, a double-clicking operation, a dragging operation, or pressing and holding operation, or the like of the user.

According to the method for controlling multipicture display provided by the embodiment, because a user can perform an operation such as clicking and dragging on a multipicture division line in a multipicture display mode on a control device, a multipicture display mode formed according to an adjusted multipicture division line is obtained, so as to implement visual and flexible settings of a multipicture display mode.

### Embodiment 2

On a basis of Embodiment 1, in the method for controlling multipicture display according to the embodiment, a user can set a multipicture display mode by touching a control device. The user can perform operations, such as generation, deletion, movement, and rotation, on a multipicture division line (hereinafter referred to as division line for short) using a manner of touching a control area of the control device. The following separately describes in detail the forgoing various operations on a multipicture division line.

(1) The user taps to generate a division line.

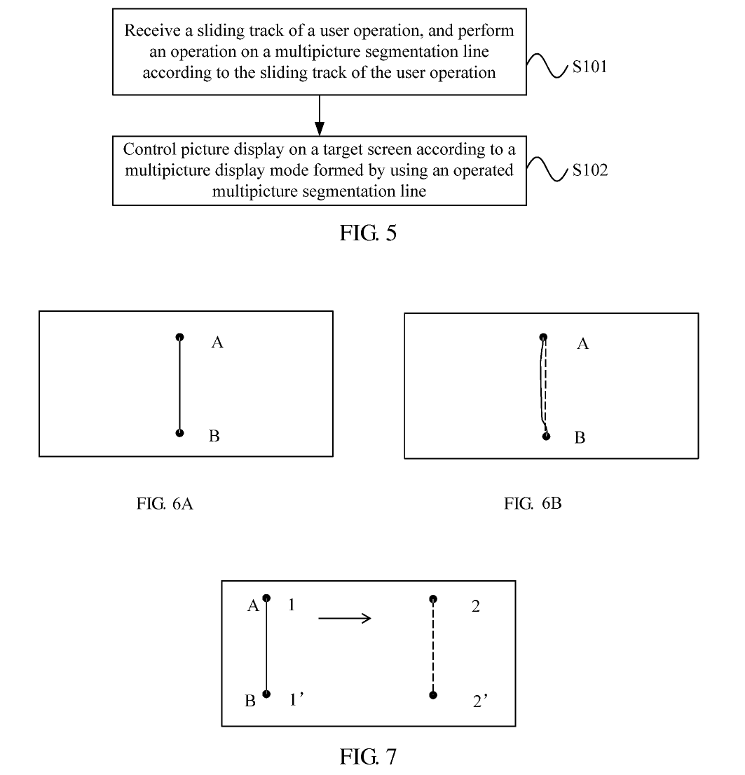

FIGS. 6A-6B are schematic diagrams of generating a multipicture division line. As shown in FIGS. 6A-6B, for example, a user wants to draw a line from a point A to a point B on a screen. The user may first use a finger to tap the point A on the screen, and then use a finger to tap the point B on a screen of the control device. After the operation is ended, a straight line from A to B is obtained, as shown in FIG. 6A. This operation is saved as generation information of a multipicture division line. The user may also, after tapping the point A, drag on the screen. The control device records a track of a finger touching the screen and generates a curve from the point A to the point B, as shown by a solid line in FIG. 6B. After the user ends an operation, the control device generates a straight line from the point A to the point B according to coordinates of the point A and the point B of the curve, as shown by a dotted line in FIG. 6B. Attribute information of the straight line may include coordinates (a coordinate of a start endpoint A and a coordinate of an end endpoint B) of endpoints of the straight line, and is saved as the generation information of a multipicture division line. If the control device allows the user to drag freely in a drawing process, a slope of a straight line between the point A and the point B finally generated needs to be calculated; and the control device may further impose a constraint when the user generates the division line, that is, the division line is only allowed to extend along a horizontal or vertical direction when drawing is performed.

(2) The user moves (horizontally) a division line using the touching manner.

FIG. 7 is a schematic diagram of moving a multipicture division line. As shown in FIG. 7, first, select a division line AB using the touching manner. The selection may be implemented in a manner of touching & holding the division line. Then, drag the division line AB from a location 11′ to 22′ using the touching manner. After the operation is completed, an endpoint coordinate of 22′ is used as new attribute information of the straight line. This operation corresponds to multipicture division line movement information for moving a division line.

The following describes the manner of selecting a division line in detail. FIG. 8 is a first schematic diagram of selecting a multipicture division line. Use a manner of tapping and selecting to select a division line, that is, receive a tapping operation performed by the user on the multipicture division line, and determine that a multipicture division line selected by the tapping operation is a to-be-operated multipicture division line. As shown in FIG. 8, a typical 3×3 multipicture configuration mode is used as an example. A line from a point A to a point H consists of three division line segments, that is, an AC, a CE, and an EH. When the user needs to select a division line segment for operating, the user uses a finger to select any point between two endpoints of the division line segment so that the division line segment can be selected for operating. For example, if the segment AC is to be operated, use a finger to select a point B on the segment AC. This applies to performing selection of a line segment that has no other middle division point except endpoints, and performing operations such as deletion and movement. If a cross-segment operation is to be performed, for example, a segment AE is to be operated, a point (for example, the point B) of the segment AC and a point (for example, a point D) on a segment CE need to be separately selected. The selected segments AC and CE may be seen as an entire division line for operating. For example, a segment AH is to be operated. Then, a point needs to be selected separately on the segment AC and a segment EH, for example, the point B and a point F. The foregoing uses a manner of selecting a point to determine a to-be-selected division line.

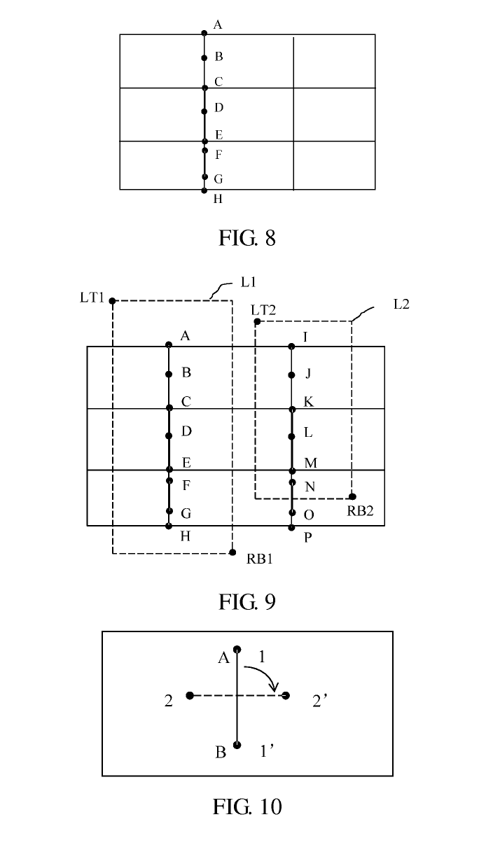

In addition, a frame selection manner may be used to select a to-be-operated segment line. FIG. 9 is a second schematic diagram of selecting a multipicture division line. As shown in FIG. 9, to select AH, first select a point LT1 on the screen. The point LT1 must be outside a display frame corresponding to the screen. Then, slide to a point RB1 in an area outside a multipicture screen. The LT1 and the RB1 are an upper-left vertex coordinate and a lower-right vertex coordinate of a selection frame, respectively. It may be seen that a division line entirely included by the frame L1 includes the AH. Then, it indicates that the AH is selected. Similarly, because an L2 formed using an upper-left vertex coordinate LT2 and a lower-right vertex coordinate RB2 does not entirely include an IP, the L2 can be used to select a division line IM for a further operation.

(3) The user deletes a division line using the touching manner.

The user first selects a division line that is used to divide a multipicture on the screen, then drags the division line out of the control area according to the foregoing manner of moving a division line, which indicates that the division line no longer affects configuration of a multipicture, and a corresponding multipicture is generated by another division line for configuring a multipicture. This operation corresponds to multipicture division line deletion information for deleting a division line.

(4) The user rotates a division line using the touching manner.

FIG. 10 is a first schematic diagram of rotating a multipicture division line. As shown in FIG. 10, first, select a division line AB using the touching manner. The selection may be implemented in a manner of touching & holding the division line. Use two fingers to select two points on the division line AB, and then rotate the division line AB from 11′ to 22′ using the touching manner. After the operation is completed, an endpoint coordinate of 22′ is used as new attribute information of the division line. This operation corresponds to multipicture division line rotation information for rotating a division line.

Except that the user performs an operation on a division line using the foregoing manner, an auxiliary area of the control device may further provide operation buttons corresponding to various operation instructions of a multipicture division line, for example, including a multipicture division line generation button, a multipicture division line movement button, a multipicture division line rotation button, or a multipicture division line deletion button. In this case, the user may complete an operation on a division line by tapping a corresponding operation button, and selecting a division line to be operated, and a relevant location. Because in an actual application, a multipicture division line should generally be vertical or horizontal, a rotation angle is generally 90 degrees or 180 degrees. However, as a technical solution, the present invention does not exclude a rotation operation of non-90 degrees or non-180 degrees. An implementation manner hereof is similar, and details are not described repeatedly herein.

After obtaining corresponding operation information of a multipicture division line using the foregoing user operation, the control device generates a corresponding multipicture display mode according to the operation information of the multipicture division line, which is described in detail as follows:

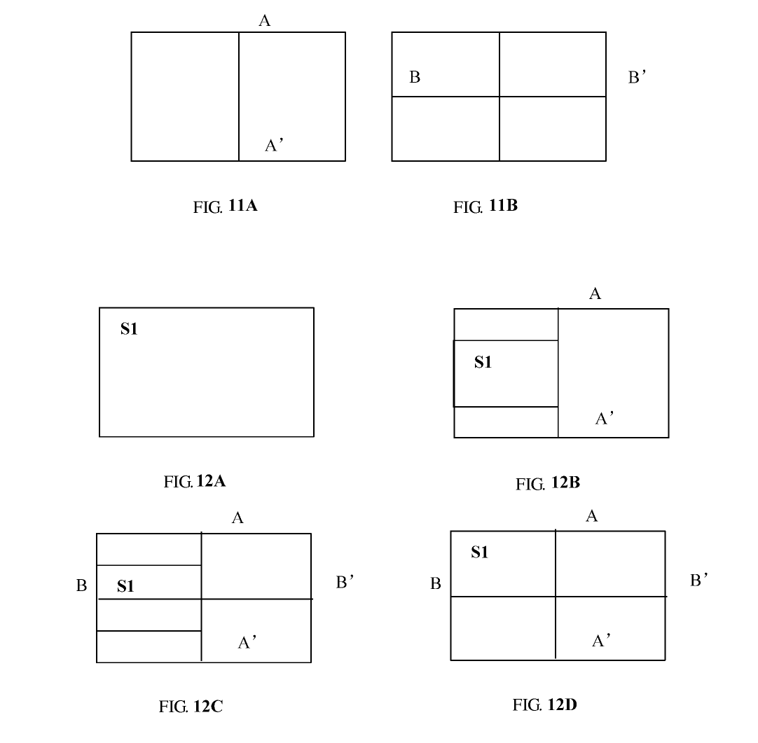

FIGS. 11A-11B are first schematic diagrams of setting a multipicture display mode according to multipicture division line generation information. As shown in FIGS. 11A-11B, for example, a four-picture multipicture display mode is to be configured on a screen that does not have any conference site image displayed, the following two steps are included:

(1) First, use a piece of multipicture division line generation information to generate a first division line AA′, and divide a target screen into a 1×2 multipicture.

(2) Use another piece of multipicture division line generation information to generate a second division line BB′, and adjust a picture display mode of the target screen to be a 2×2 multipicture.

FIGS. 12A-12B are second schematic diagrams of setting a multipicture display mode according to multipicture division line generation information. As shown in FIGS. 12A-12B, for example, a four-picture multipicture display mode is to be configured for a screen on which a conference site image is currently displayed in a single-picture display mode. Then, when a conference site S1 is already displayed on the target screen (as shown in FIG. 12A), after the first division line AA′ is generated, the conference site S1 is automatically adjusted to be displayed in a left display area (as shown in FIG. 12B). After that, the second division line BB′ (as shown in FIG. 12C) is generated, the screen is adjusted to be a four-picture display mode, and the conference site S1 is automatically adjusted to be displayed in a upper-left display area (as shown in FIG. 12D).

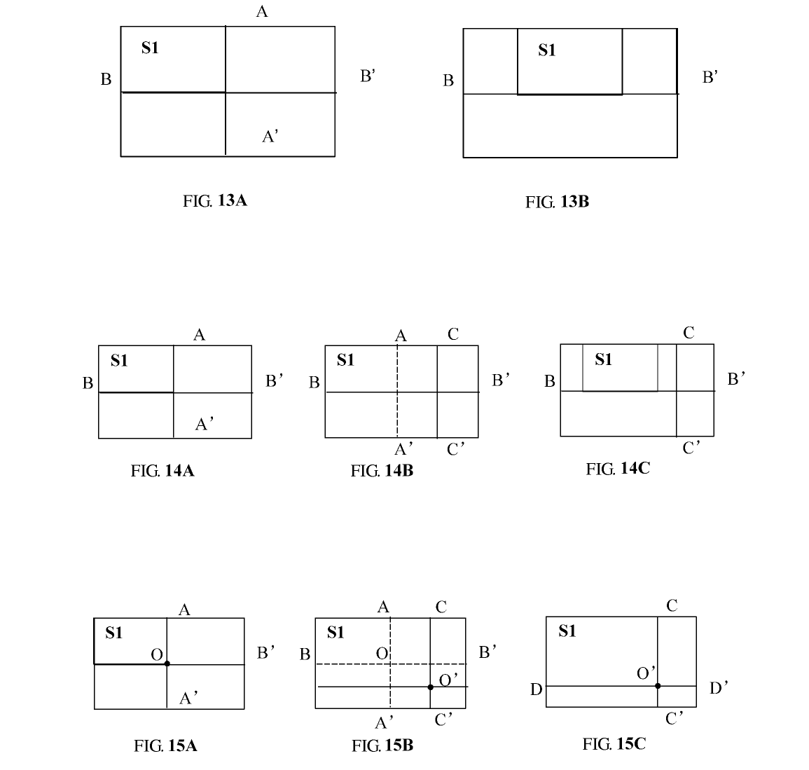

FIGS. 13A-13B are first schematic diagrams of setting a multipicture display mode according to multipicture division line deletion information. As shown in FIGS. 13A-13B, for example, a 1×2 multipicture display mode is to be configured for a four-picture screen that has a conference site S1 displayed. In an initial state, the multipicture display mode is shown in FIG. 13A. A picture of the conference site S1 is displayed on an upper-left corner of the target screen. Delete a division line AA′, and a generated multipicture display mode is shown in FIG. 13B. The picture of the conference site S1 is automatically adjusted to be displayed in an upper half display area. By now, a 1×2 multipicture display mode is obtained.

FIGS. 14A-14C are first schematic diagrams of setting a multipicture display mode according to multipicture division line movement information. The control device may implement size adjusting of each sub-picture in a multipicture display mode according to the multipicture division line movement information. As shown in FIGS. 14A-14C, in the initial state, the multipicture display mode is shown in FIG. 14A. A conference site S1 is displayed in an upper-left area of the target screen. The control device moves a division line AA′ to a CC′ according to the multipicture division line moving information, and the multipicture display mode at this moment is shown in FIG. 14B. After that, the control device automatically adjusts a picture of the conference site S1 to be displayed in a middle position of a sub-picture, and both sides of the sub-picture are idle areas, as shown in FIG. 14C. The control device may further perform cropping and/or scaling on an image of the conference site S1 in the sub-picture according to an adjusted sub-picture size, so that the image of the conference site S1 fills up the sub-picture.

FIGS. 15A-15C are second schematic diagrams of setting a multipicture display mode according to multipicture division line moving information. The user may also move two mutually cross division lines simultaneously to set a multipicture mode. As shown in FIG. 15A, a conference site S1 is displayed in an upper-left area of the target screen, and an intersection point of an AA′ and a BB′ is a point O. As shown in FIG. 15B, the user selects an intersection point O of division lines AA′ and BB′, and drags the intersection point to O′. Then, the division line AA′ is moved to the position of CC′, and BB′ is moved to the position of DD′. The control device adjusts a multipicture to a four-picture shown in FIG. 15C, and automatically resizes the conference site S1 according to a new area size for display.

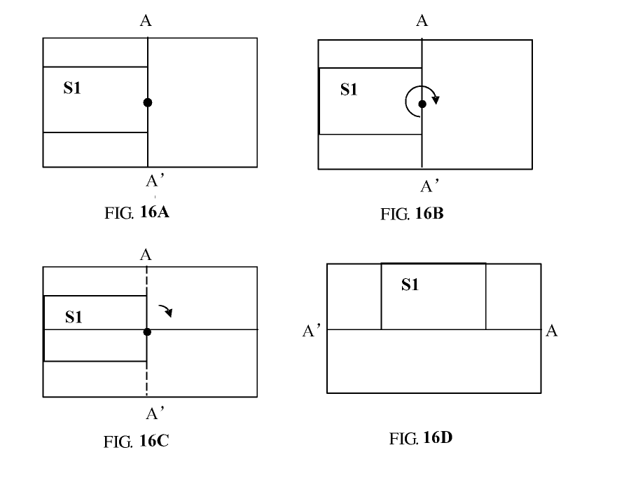

FIGS. 16A-16D are first schematic diagrams of setting a multipicture display mode according to multipicture division line rotation information. An example in which a multipicture display mode in which pictures are displayed in a left and right manner is adjusted to be a multipicture display mode in which pictures are displayed in an upper and lower manner is used for description. In the initial state, as shown in FIG. 16A, an image of a conference site S1 is displayed on the left of the screen. As shown in FIG. 16B, the user selects a division line AA′. As shown in FIG. 16C, rotate the division line AA′ clockwise. Then, the AA′ changes from a vertical direction to a horizontal direction. The control device automatically adjusts the conference site S1 to be displayed in an upper area of the target screen, and a multipicture display mode shown in FIG. 16D is obtained.

According to the method for setting a multipicture display mode provided in the embodiment, a user can flexibly perform operations such as generation, deletion, movement, and rotation by touching, with a hand, a control area of a control device, which implements effective and convenient setting of a multipicture display mode.

### Embodiment 3

On a basis of Embodiment 1, in the method for setting a multipicture display mode according to the embodiment, a user can set a multipicture display mode by performing an operation with a mouse. The user can perform an operation using a mouse on a control area, so as to implement operations, such as generation, deletion, movement, and rotation, on a multipicture division line (hereinafter referred to as a division line for short). A manner of selecting a division line in the embodiment is the same as the manner introduced in Embodiment 2. The following separately describes in detail the forgoing various operations on a multipicture division line.

(1) The user clicks to generate a division line.

FIGS. 6A-6B are still used as an example. A user wants to draw a line from a point A to a point B on a screen. The user may first move a cursor to the point A on the screen and clicks it, and then moves the cursor to the point B on a screen of the control device and clicks it. After the operation is ended, a straight line from A to B is obtained, as shown in FIG. 6A. This operation is saved as generation information of a multipicture division line. The user may also, after clicking the point A, drag on the screen. The control device records a track of cursor moving on the screen and generates a curve from the point A to the point B, as shown by a solid line in FIG. 6B. After the user ends an operation, the control device generates a straight line from the point A to the point B according to coordinates of the point A and the point B of the curve, as shown by a dotted line in FIG. 6B. Attribute information of the division line includes coordinates (a start endpoint and an end coordinate) of the division line, and is saved as the generation information of a multipicture division line. If the control device allows the user to drag freely in a drawing process, a slope of a straight line between the point A and the point B finally generated needs to be calculated; and the control device may further impose a constraint when the user generates the division line, that is, the division line is only allowed to extend along a horizontal or vertical direction when drawing is performed.

(2) The user moves a division line using the mouse manner.

FIG. 7 is still used as an example. First, select a division line AB using the mouse. The selection may be implemented in a manner of clicking a left button of the mouse. Select the division line, and drag the division line AB from a location 11′ to 22′. After the operation is completed, an endpoint coordinate of 22′ is used as new attribute information of the straight line. This operation corresponds to multipicture division line movement information for moving a division line.

(3) The user deletes a division line using the mouse manner.

The user first selects a division line that is used to divide a multipicture on the screen, then drags the division line out of the control area according to the foregoing manner of moving a division line, which indicates that the division line no longer affects configuration of a multipicture, and a corresponding multipicture is generated by another division line for configuring a multipicture. This operation corresponds to multipicture division line deletion information for deleting a division line.

(4) The user rotates a division line using the mouse manner.

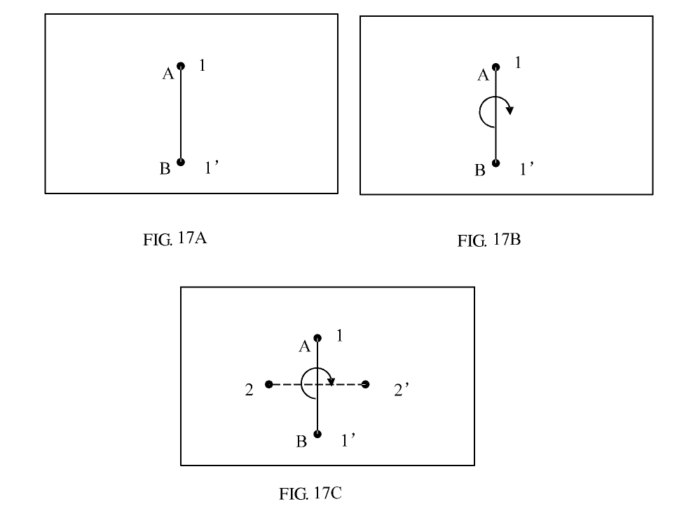

FIGS. 17A-17C are second schematic diagrams of rotating a multipicture division line. When a multipicture division line is rotated, operations using the mouse manner and operations using the touching manner are different. For example, a division line is to be changed from a vertical position to a horizontal position. As shown in FIGS. 17A-17C, first, select a to-be-rotated division line AB (as shown in FIG. 17A). After selection, when the cursor is moved close to a central position (for example, a distance away from the central point of an AB is less than ⅓ of a distance from a point A to a point B), a rotatable symbolic prompt (as shown in FIG. 17B) may appear. When the rotatable symbolic prompt appears, hold the left button of the mouse and drag toward the right, so that a rotation from a vertical position to a horizontal position can be completed (as shown in FIG. 17C). After the operation is completed, an endpoint coordinate of 22′ is used as new attribute information of the straight line. This operation corresponds to multipicture division line rotation information for rotating a division line.

After the control device obtains corresponding operation information on a multipicture division line using the foregoing user operation, a specific process of generating a corresponding multipicture display mode according to the operation information of a multipicture division line is the same as that described in Embodiment 2, and thereby details are not described herein again.

### Embodiment 4

In addition to the acquiring operations of the user directly performed on a division line in Embodiment 2 or 3, the control device may further acquire a dragging operation performed by a user on a conference picture, generate corresponding multipicture division line operation information according to the dragging operation, and generate a multipicture display mode according to the multipicture division line operation information.

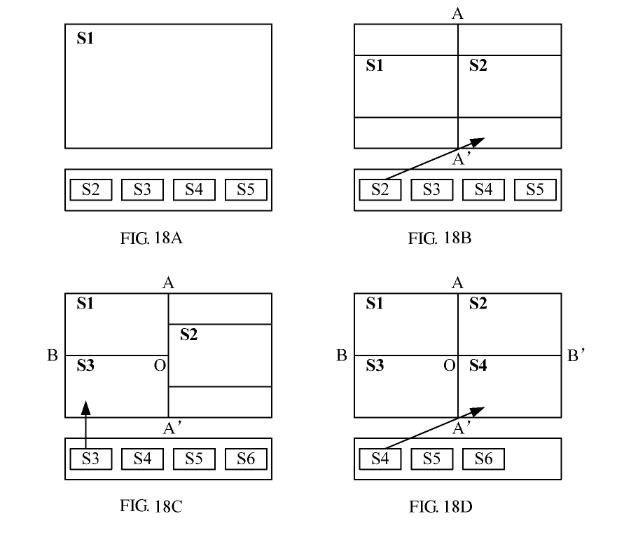

FIGS. 18A-18D are third schematic diagrams of setting a multipicture display mode according to multipicture division line generation information. As shown in FIGS. 18A-18D, for example, there are currently six conference pictures that can be displayed, that is, a conference site S1 to a conference site S6. An auxiliary area of the control device may be used to display conference site pictures that are not displayed in four current screens. For example, in an initial state, a single screen displays a picture of the conference site S1, the auxiliary area displays small pictures of a conference site S2 to a conference site S5, and at this moment, a multipicture display mode is shown in FIG. 18A. The user drags a picture of the conference site S2 displayed in the auxiliary area into the right of a target screen. The picture dragging operation performed by the user implies generating a division line AA′. The control device generates multipicture division line generation information according to the picture dragging operation performed by the user, and generates the division line AA′ according to the multipicture division line generation information. At this moment, the multipicture display mode is shown in FIG. 18B. After the foregoing operation is completed, the auxiliary area displays small pictures of a conference site S3 to the conference site S6. The user drags a picture of the conference site S3 displayed in the auxiliary area into the lower left of the target screen. The picture dragging operation performed by the user implies generating a division line BO. The control device generates multipicture division line generation information according to the picture dragging operation performed by the user, and generates the division line BO according to the multipicture division line generation information. At this moment, the multipicture display mode is shown in FIG. 18C. After the foregoing operation is completed, the auxiliary area displays small pictures of a conference site S4 to the conference site S6. The user drags a picture of the conference site S4 displayed in the auxiliary area into the lower right of the target screen. The picture dragging operation performed by the user implies generating a division line OB′. The control device generates multipicture division line generation information according to the picture dragging operation performed by the user, and generates the division line OB′ according to the multipicture division line generation information. At this moment, the multipicture display mode is shown in FIG. 18A. By now, configuring a single-picture display mode as a 2×2 multipicture is completed, and each display area of the screen, that is, each sub-picture displays a conference site picture specified by the user.

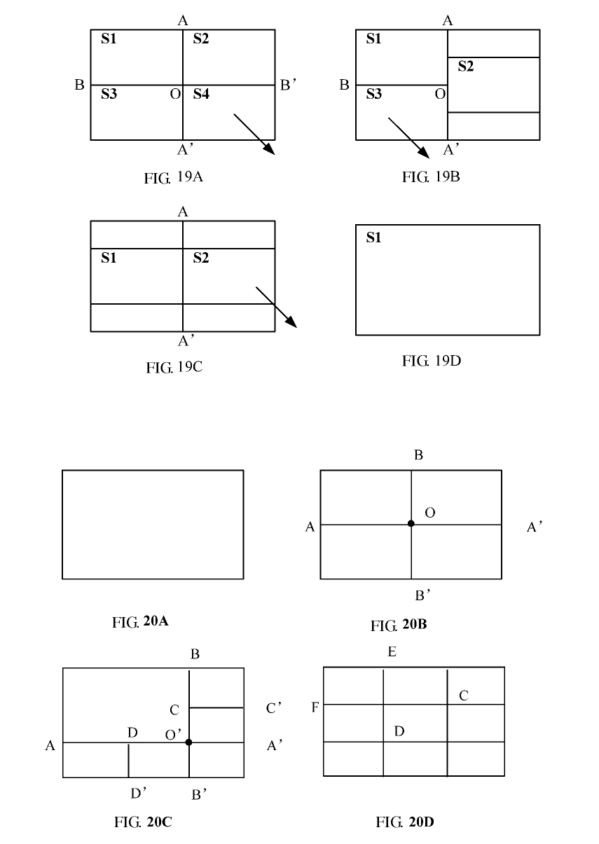

In addition to deleting a division line using a method for dragging the division line, a division line may also be deleted using a method for dragging a conference site picture out of a display area, so as to obtain a new multipicture display mode. FIGS. 19A-19D are second schematic diagrams of setting a multipicture display mode according to multipicture division line deletion information. As shown in FIGS. 19A-19D, an example in which a 1×2 multipicture display mode is configured for a four-picture screen that has a conference site S1 displayed is used for description. As shown in FIG. 19A, the target screen is in a 4×4 multipicture display mode. The user drags a picture of a conference site S4 shown in FIG. 19A out of the display area, which implies deleting a division line OB′, so as to form a multipicture display mode shown in FIG. 19B. The user drags a conference site S3 in FIG. 19B out of the display area, which implies deleting a division line BO, so as to form a multipicture display mode shown in FIG. 19C. The user drags a conference site S2 in FIG. 19C out of the display area, which implies deleting a division line AA′, so as to form a multipicture display mode shown in FIG. 19D.

In addition, a division line may further be moved or rotated by performing an operation on a conference site picture, so as to obtain a new multipicture display mode.

Receive a sliding track of a size adjusting operation performed by the user on the to-be-operated conference site picture, and according to the sliding track of size adjusting, move a multipicture division line that is used to form a border line of a display area for displaying the to-be-operated conference site picture. For example, adjusting a size of a conference site picture by dragging the border of the conference site picture is equivalent to moving two mutually cross division lines simultaneously, as shown in FIGS. 15A-15C, to perform multipicture display control.

Receive a sliding track of a dragging operation performed by the user on the to-be-operated conference site picture on the target screen, and according to the sliding track of the dragging operation, rotate the multipicture division line that is used to form a border line of a display area for displaying the to-be-operated conference site picture. FIGS. 16A-16D are used as an example, when a conference site picture S1 is dragged from the left position shown in FIG. 16A to the upper position shown in FIG. 16D, multipicture division line rotation information for rotating the division line AA′ from a position shown in FIG. 16A to a location shown in FIG. 16D can be automatically generated.

### Embodiment 5

On a basis of the foregoing embodiment, the control device may further combine multiple pieces of multipicture division line operation information to set a multipicture display mode, so as to obtain a multipicture display mode expected by a user.

FIGS. 20A-20D are schematic diagrams of setting a multipicture display mode according to multiple pieces of multipicture division line operation information. As shown in FIGS. 20A-20D, setting a single-picture display mode to a 3×3 multipicture display mode needs to be implemented using four times' adjusting. In an initial state, a display mode of a screen is shown in FIG. 20A. A division line BB′ is generated, and a display mode of the screen is switched to a 1×2 multipicture display mode; and a division line AA′ is generated, and the display mode of the screen is switched to a 2×2 multipicture display mode, as shown in FIG. 20B. An intersection point O of the BB′ and the AA′ is dragged to an OO′ to generate a division line DD′ and generate a division line CC′, and a multipicture display mode shown in FIG. 20C is obtained. A division line DE and a division line FC are generated, and a multipicture display mode shown in FIG. 20D is finally formed.

### Embodiment 6

On a basis of any one of the foregoing embodiments, the controlling picture display on a target screen according to a multipicture display mode formed using the multipicture division line that is obtained after an operation includes retrieving a second multipicture display mode that is close to a first multipicture display mode from prestored multipicture display modes, and controlling picture display on the target screen according to the second multipicture display mode; where the first multipicture display mode is the multipicture display mode formed using the multipicture division line that is obtained after the operation; and the second multipicture display mode and the first multipicture display mode have the same number of display areas; or an area difference between the second multipicture display mode and the first multipicture display mode is less than an area difference between any other multipicture display mode in the prestored multipicture display modes and the first multipicture display mode.

Because common video image display formats include 4:3, 16:9, and the like, if a user sets an image size to any scale, an image of a relevant conference site is adjusted to be of a size and scale set by the user; then, operations of cropping and scaling need to be performed in most cases. This consumes a considerable amount of computation of a device, which leads to generation of end-to-end delay of a system. Therefore, various multipicture display modes supported by the system may be saved as a database, and after a user operation is obtained and the first multipicture display mode corresponding to the user operation is temporarily or virtually generated, the database is searched for the second multipicture display mode that is most similar to the first multipicture display mode, and the second multipicture display mode is used as the multipicture display mode of the screen. Determining of similarity is based, for example, on the number of display areas of two multipicture display modes, or difference in areas of the display areas, or the like. The following uses selecting a second multipicture display mode based on the difference in areas as an example for description.

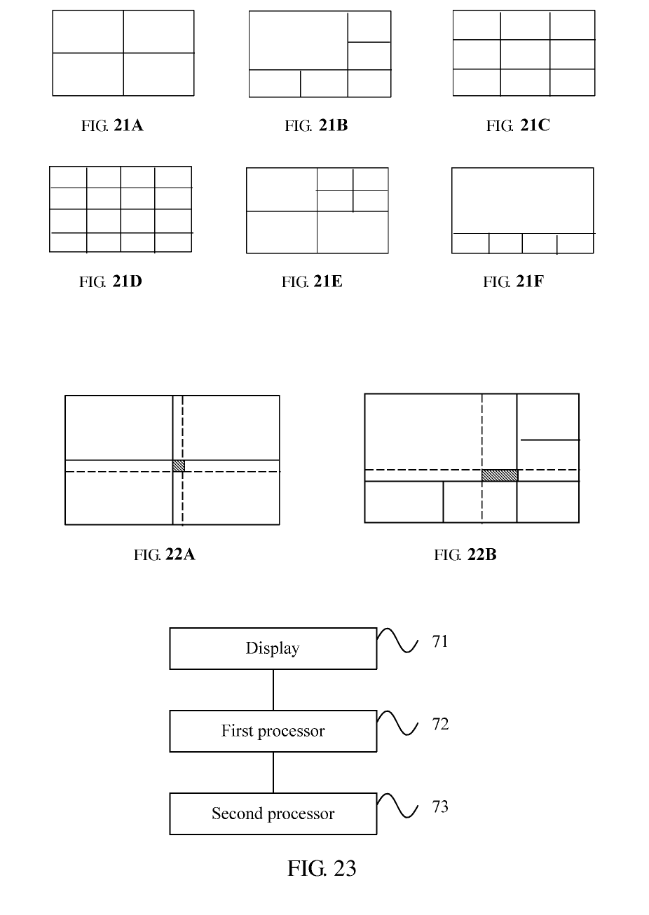

FIGS. 21A-21F are schematic diagrams of multipicture display modes stored in a database. As shown in FIGS. 21A-21F, a control device can support six multipicture display modes. FIGS. 22A-22B are schematic diagrams of selecting a second multipicture display mode according to a first multipicture display mode. As shown in FIGS. 22A-22B, a dotted line is used to represent the first multipicture display mode formed according to the user operation, so as to represent multipicture display modes supported by the database. In FIG. 22A, the first multipicture display mode is compared with a first type of a multipicture display mode (as shown in FIG. 21A) in the database, where a shaded area is an area difference between the two and is recorded as a first difference area. In FIG. 22B, the first multipicture display mode is compared with a second type of a multipicture display mode (as shown in FIG. 21B) in the database, where a shaded area is an area difference between the two and is recorded as a second difference area. According to a same manner, area differences between the first multipicture display mode and each of the remaining four types of multipicture display modes in the database can be obtained, and are not shown herein. By comparing each difference area, for example, if it is learned that the first difference area is less than the second difference area (as well as each of other difference areas), the second type of the multipicture display mode may be selected as the multipicture display mode of the screen.

In the foregoing method for controlling multipicture display according to Embodiments 1 to 6, though an example in which the user provides a sliding track of a user operation to the control device by a touching operation or a mouse operation is used to describe the method for controlling multipicture display in the embodiments of the present invention, a person skilled in the art can understand that the control device may further receive the sliding track of the user by means of any other manner so as to be capable of implementing technical solutions of the embodiments of the present invention.

For example, the control device receives a sliding track of a user operation using hand gesture identification. A user operation corresponding to a user hand gesture is prestored in the control device. When the user hand gesture and a hand gesture moving position are acquired using a camera, the user operation is identified according to a mapping relationship between a user hand gesture and a user operation, and a sliding track of the user operation is obtained according to a moving position of the user hand gesture. For example, when the camera identifies a hand gesture that an index finger of the user unbends and the other four fingers are folded, it is learned that the hand gesture corresponds to a multipicture division line generation operation according to the prestored mapping relationship between a user hand gesture and a user operation; and it is identified that the user keeps the hand gesture and moves from a position (corresponding to a first coordinate) to another position (corresponding to a second coordinate), then a multipicture division line that uses the first coordinate and the second coordinate as endpoints is generated. Similarly, the technical solutions of the embodiments of the present invention can be implemented by predefining different user hand gestures separately corresponding to a multipicture division line deletion operation, movement operation, and rotation operation.

### Embodiment 7

The apparatus for controlling multipicture display provided in the embodiment is configured to execute the method for controlling multipicture display according to any one of the foregoing embodiments. The apparatus for controlling multipicture display, for example, is the control device in the foregoing embodiments, and may be separately disposed or be disposed with a terminal, a personal telepresence or three-screen telepresence device, or the like, in an integrated manner.

FIG. 23 is a schematic structural diagram of an apparatus for controlling multipicture display according to Embodiment 7 of the present invention. As shown in FIG. 23, the apparatus for controlling multipicture display includes a display 71, a first processor 72, and a second processor 73, where the first processor 72 is separately connected to the display 71 and the second processor 73; where the display 71 is configured to receive a sliding track of a user operation and send the sliding track of the user operation to the first processor 72; the first processor 72 is configured to perform an operation on a multipicture division line according to the sliding track of the user operation and send a multipicture division line that is obtained after the operation to the second processor 73; and the second processor 73 is configured to control picture display on a target screen according to a multipicture display mode formed using the multipicture division line that is obtained after the operation.

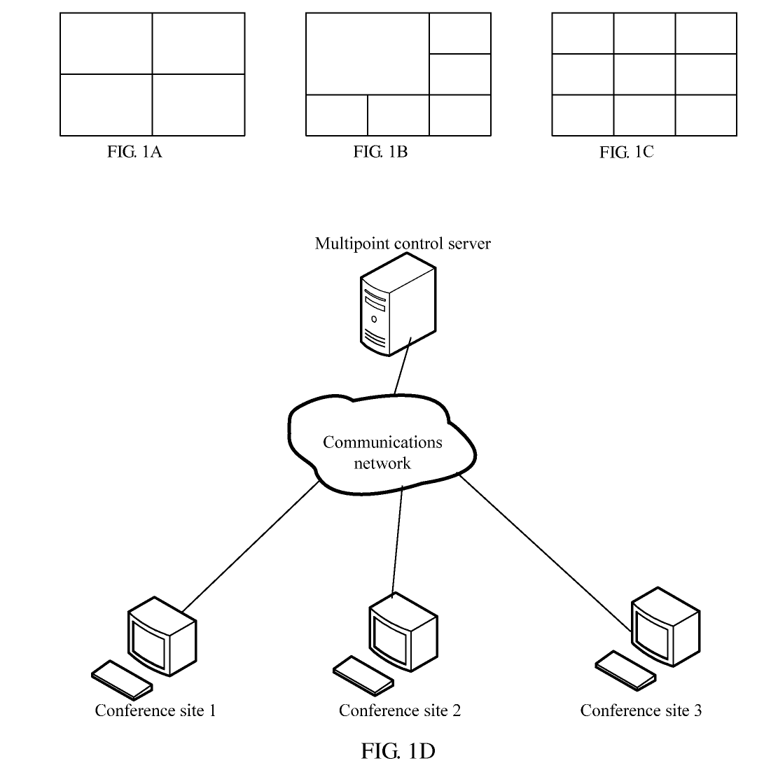

The display 71, for example, is the display of the control device shown in FIGS. 3A-3B, and the first processor 72 and the second processor 73, for example, are processors integrated in the control device, or processors of a multipoint control server shown in FIG. 1, where the multipoint control server is connected to a control device of each conference site.

A process in which the apparatus for controlling multipicture display according to the embodiment executes multipicture display control is the same as the method for controlling multipicture display in the foregoing embodiments, and thereby details are not described herein again.

According to the apparatus for controlling multipicture display provided by the embodiment, because a user can perform an operation on a multipicture division line in a multipicture display mode by performing operations, such as clicking and dragging, on an apparatus for setting a multipicture display mode, a multipicture display mode formed according to an adjusted multipicture division line is obtained, which implements visual and flexible setting of a multipicture display mode.

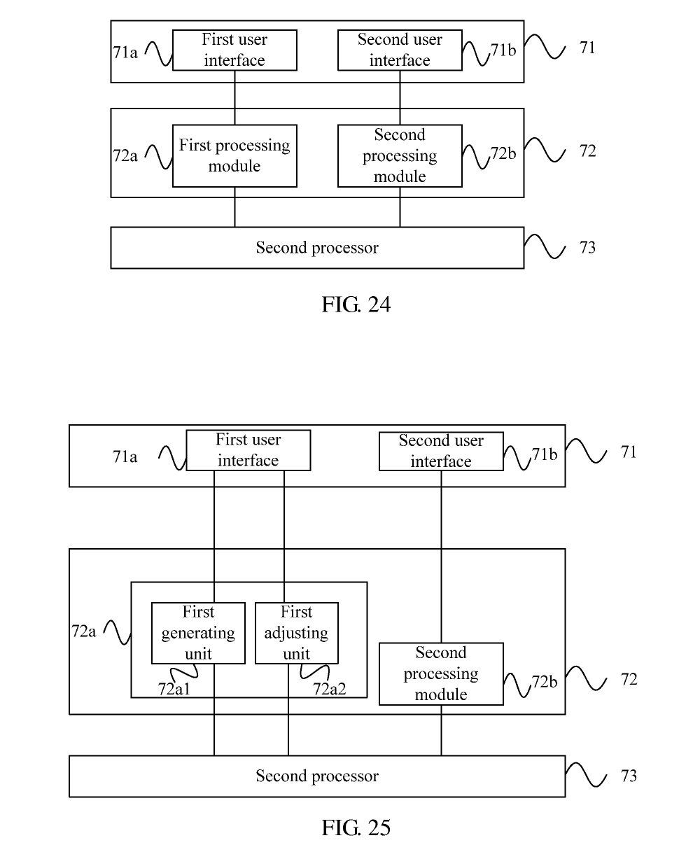

Further, FIG. 24 is a schematic structural diagram of an apparatus for controlling multipicture display according to another embodiment of the present invention. As shown in FIG. 24, in the apparatus for controlling multipicture display according to the foregoing embodiment, the display 71 includes a first user interface 71a configured to receive a sliding track of an operation performed by a user on a multipicture division line, and send, to the first processor, the sliding track of the operation performed by the user on the multipicture division line; or a second user interface 71b configured to receive a sliding track of an operation performed by a user on a conference site picture displayed on the target screen, and send, to the first processor 72, the sliding track of the operation performed by the user on the conference site picture displayed on the target screen; where correspondingly, the first processor 72 includes a first processing module 72a configured to perform an operation on a multipicture division line according to the sliding track of the operation performed by the user on the multipicture division line; or a second processing module 72b configured to perform an operation on a multipicture division line according to the sliding track of the operation performed by the user on the conference site picture displayed on the target screen.

Further, FIG. 25 is a schematic structural diagram of an apparatus for controlling multipicture display according to still another embodiment of the present invention. As shown in FIG. 25, in the apparatus for controlling multipicture display according to the foregoing embodiment, the first processing module 72a includes a first generating unit 72a1 configured to receive, through the first user interface 71a, a sliding track of the user from a first coordinate point to a second coordinate point, so as to generate a multipicture division line that uses the first coordinate point and the second coordinate point as endpoints; or a first adjusting unit 72a2 configured to receive, through the first user interface 71a, a selection operation, of the user, of selecting a multipicture division line, and determine a to-be-operated multipicture division line according to the selection operation; and receive, through the first user interface 71a, a sliding track of an operation performed by the user on the to-be-operated multipicture division line, and according to the sliding track of the operation performed by the user on the to-be-operated multipicture division line, perform movement, rotation, or deletion on the to-be-operated multipicture division line.

Further, in the apparatus for controlling multipicture display according to the foregoing embodiment, the first user interface is configured to receive a clicking operation performed by the user on a multipicture division line, and send the clicking operation performed by the user on the multipicture division line to the first adjusting unit; and correspondingly, the first adjusting unit is configured to determine that the multipicture division line selected by the clicking operation is the to-be-operated multipicture division line; or the first user interface is configured to receive a frame selection operation performed by the user, and send the frame selection operation performed by the user to the first adjusting unit; and correspondingly, the first adjusting unit is configured to determine that a multipicture division line that is in a selection frame range formed by performing the frame selection operation is the to-be-operated multipicture division line.

Further, in the apparatus for controlling multipicture display according to the foregoing embodiment, the first user interface is configured to receive a sliding track of a dragging operation performed by the user on the to-be-operated multipicture division line on the target screen, and send, to the adjusting unit, the sliding track of the dragging operation performed by the user on the to-be-operated multipicture division line on the target screen; and correspondingly, the first adjusting unit is configured to move, according to the sliding track of the dragging operation performed by the user on the to-be-operated multipicture division line on the target screen, the to-be-operated multipicture division line to an end position of the sliding track of the dragging operation; or the first user interface is configured to receive a sliding track of dragging, by the user, the to-be-operated multipicture division line out of the target screen, and send, to the first adjusting unit, the sliding track of dragging, by the user, the to-be-operated multipicture division line out of the target screen; and correspondingly, the first adjusting unit is configured to delete the to-be-operated multipicture division line according to the sliding track of dragging, by the user, the to-be-operated multipicture division line out of the target screen; or the first user interface is configured to receive a sliding track of a rotation operation performed by the user on the to-be-operated multipicture division line, and send the sliding track of the rotation operation performed by the user on the to-be-operated multipicture division line to the first adjusting unit; and correspondingly, the first adjusting unit is configured to rotate the to-be-operated multipicture division line according to the sliding track of the rotation operation performed by the user on the to-be-operated multipicture division line.

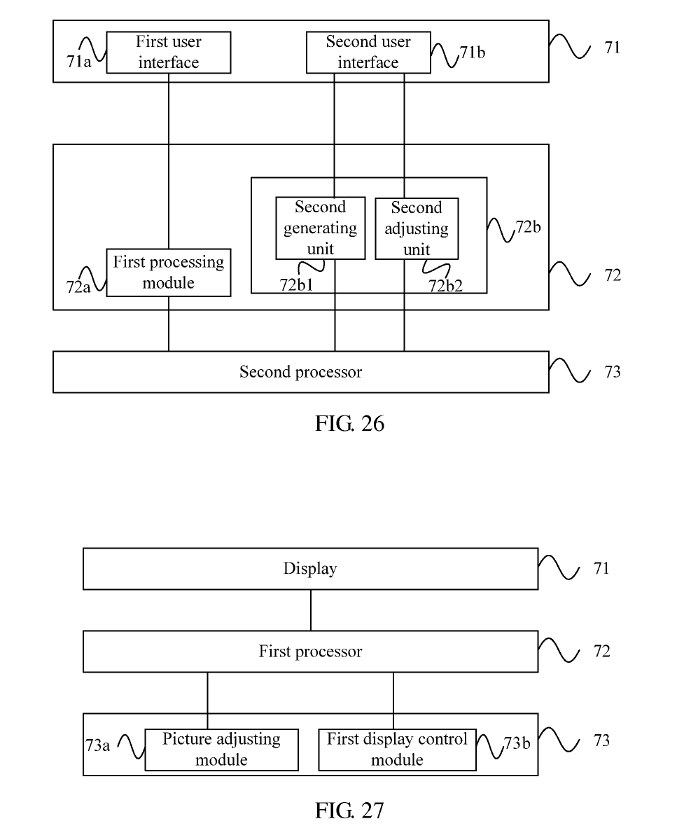

Further, FIG. 26 is a schematic structural diagram of an apparatus for controlling multipicture display according to yet another embodiment of the present invention. As shown in FIG. 26, in the apparatus for controlling multipicture display according to the foregoing embodiment, the second processing module 72b includes a second generating unit 72b1 configured to receive, through the second user interface 71b, a sliding track of dragging, by the user, a conference site picture into the target screen, and according to the sliding track of dragging the conference site picture, generate a multipicture division line that is used to form a border line of a display area for displaying the conference site picture that is dragged; a second adjusting unit 72b2 configured to receive, through the second user interface 71b, a selection operation, of the user, of selecting a conference site picture displayed on the target screen, and determine a to-be-operated conference site picture according to the selection operation; and receive, through the second user interface 71b, a sliding track of an operation performed by the user on the conference site picture, and according to the sliding track of the operation performed by the user on the conference site picture, performing movement, rotation, or deletion on a multipicture division line that is used to form a border line of a display area for displaying the to-be-operated conference site picture.

Further, in the apparatus for controlling multipicture display according to the foregoing embodiment, the second user interface is configured to receive a sliding track of a size adjusting operation performed by the user on the to-be-operated conference site picture, and send, to the second adjusting unit, the sliding track of the size adjusting operation performed by the user on the to-be-operated conference site picture; and correspondingly, the second adjusting unit is configured to, according to the sliding track of the size adjusting operation performed by the user on the to-be-operated conference site picture, move the multipicture division line that is used to form a border line of a display area for displaying the to-be-operated conference site picture; the second user interface is configured to receive a sliding track of a dragging operation performed by the user on the to-be-operated conference site picture on the target screen, and send, to the second adjusting unit, the sliding track of the dragging operation performed by the user on the to-be-operated conference site picture on the target screen; and correspondingly, the second adjusting unit is configured to, according to the sliding track of the dragging operation performed by the user on the to-be-operated conference site picture on the target screen, rotate the multipicture division line that is used to form a border line of a display area for displaying the to-be-operated conference site picture; or the second user interface is configured to receive a sliding track of dragging, by the user, the to-be-operated conference site picture out of the target screen, and send, to the second adjusting unit, the sliding track of dragging, by the user, the to-be-operated conference site picture out of the target screen; and correspondingly, the second adjusting unit is configured to, according to the sliding track of dragging, by the user, the to-be-operated conference site picture out of the target screen, delete the multipicture division line that is used to form a border line of a display area for displaying the to-be-operated conference site picture.

Further, FIG. 27 is a schematic structural diagram of an apparatus for controlling multipicture display according to yet another embodiment of the present invention. As shown in FIG. 27, in the apparatus for controlling multipicture display according to the foregoing embodiment, the second processor 73 includes a picture adjusting module 73a configured to adjust a to-be-displayed conference site picture according to an aspect ratio and/or a location of each display area in a formed multipicture display mode; and a first display control module 73b configured to control an adjusted conference site picture to be displayed in the display area on the target screen.

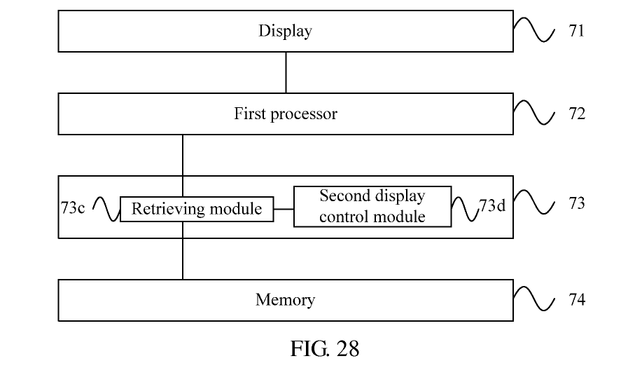

Further, FIG. 28 is a schematic structural diagram of an apparatus for controlling multipicture display according to yet another embodiment of the present invention. As shown in FIG. 28, in the apparatus for controlling multipicture display according to the foregoing embodiments, the apparatus further includes a memory 74, which is connected to the second processor 73 and is configured to prestore multipicture display modes; and correspondingly, the second processor 73 includes a retrieving module 73c configured to retrieve a second multipicture display mode that is close to a first multipicture display mode from the multipicture display modes prestored in the memory; where the first multipicture display mode is the multipicture display mode formed using the multipicture division line that is obtained after the operation; and the second multipicture display mode and the first multipicture display mode have the same number of display areas, or an area difference between the second multipicture display mode and the first multipicture display mode is less than an area difference between any other multipicture display mode in the prestored multipicture display modes and the first multipicture display mode; and a second display control module 73d configured to control picture display on the target screen according to the second multipicture display mode.

Further, in the apparatus for controlling multipicture display according to the foregoing embodiments, the first user interface and the second user interface are configured to receive a touching operation performed by the user, or receive a mouse operation performed by the user, or identify a sliding track of a hand gesture of the user.

### Embodiment 8

The embodiment provides a system for controlling multipicture display, the system for setting a multipicture display mode includes a target screen, and any apparatus for controlling multipicture display according to the foregoing embodiments.

A process of executing multipicture display control using the system for controlling multipicture display is the same as the method for controlling multipicture display in the foregoing embodiments, and thereby details are not described herein again.

According to the system for controlling multipicture display provided by the embodiment, because a user can perform an operation on a multipicture division line in a multipicture display mode by performing operations, such as clicking and dragging, on an apparatus for controlling multipicture display, a multipicture display mode formed according to an adjusted multipicture division line is obtained, which implements visual and flexible setting of a multipicture display mode.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a random access memory (RAM).

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A method for controlling multipicture display comprising:
receiving a sliding track of a user operation;
performing an operation on a multipicture division line according to the sliding track of the user operation; and
controlling picture display on a target screen according to a multipicture display mode formed using the multipicture division line that is obtained after the operation.

2. The method for controlling multipicture display according to claim 1, wherein receiving the sliding track of the user operation, and performing the operation on the multipicture division line according to the sliding track of the user operation further comprises:
receiving the sliding track of the operation performed by the user on the multipicture division line; and
performing the operation on the multipicture division line according to the sliding track of the operation performed by the user on the multipicture division line.

3. The method for controlling multipicture display according to claim 2, wherein receiving the sliding track of the operation performed by the user on the multipicture division line, and performing the operation on the multipicture division line according to the sliding track of the operation performed by the user on the multipicture division line further comprises:
receiving the sliding track of the user operation from a first coordinate point to a second coordinate point; and
generating the multipicture division line that uses the first coordinate point and the second coordinate point as endpoints.

4. The method for controlling multipicture display according to claim 2, wherein receiving the sliding track of the operation performed by the user on the multipicture division line, and performing the operation on the multipicture division line according to the sliding track of the operation performed by the user on the multipicture division line further comprises:
receiving a selection operation, performed by the user, of selecting the multipicture division line;
determining a to-be-operated multipicture division line according to the selection operation;
receiving the sliding track of the operation performed by the user on the to-be-operated multipicture division line; and
performing movement, rotation, or deletion on the to-be-operated multipicture division line according to the sliding track of the operation performed by the user on the to-be-operated multipicture division line.

5. The method for controlling multipicture display according to claim 1, wherein receiving the sliding track of the user operation, and performing the operation on the multipicture division line according to the sliding track of the user operation further comprises:
receiving the sliding track of the operation performed by the user on a conference site picture displayed on the target screen; and
performing the operation on the multipicture division line according to the sliding track of the operation performed by the user on the conference site picture displayed on the target screen.

6. The method for controlling multipicture display according to claim 5, wherein receiving the sliding track of the operation performed by the user on the conference site picture displayed on the target screen, and performing the operation on the multipicture division line according to the sliding track of the operation performed by the user on the conference site picture displayed on the target screen further comprises:
receiving the sliding track of dragging, by the user, the conference site picture into the target screen;
generating, according to the sliding track of dragging the conference site picture, the multipicture division line that is used to form a border line of a display area for displaying the conference site picture that is dragged;
receiving a selection operation, of the user, of selecting the conference site picture displayed on the target screen;
determining a to-be-operated conference site picture according to the selection operation;
receiving the sliding track of the operation performed by the user on the to-be-operated conference site picture, and
performing movement, rotation, or deletion on the multipicture division line that is used to form the border line of the display area for displaying the to-be-operated conference site picture, according to the sliding track of the operation performed by the user on the conference site picture.

7. The method for controlling multipicture display according to claim 6, wherein receiving the sliding track of the operation performed by the user on the conference site picture, and performing movement, rotation, or deletion on the multipicture division line that is used to form the border line of the display area for displaying the to-be-operated conference site picture, according to the sliding track of the operation performed by the user on the conference site picture, further comprises:
receiving a sliding track of a size adjusting operation performed by the user on the to-be-operated conference site picture; and
moving, according to the sliding track of the size adjusting operation, the multipicture division line that is used to form the border line of the display area for displaying the to-be-operated conference site picture.

8. The method for controlling multipicture display according to claim 6, wherein receiving the sliding track of the operation performed by the user on the conference site picture, and performing movement, rotation, or deletion on the multipicture division line that is used to form the border line of the display area for displaying the to-be-operated conference site picture, according to the sliding track of the operation performed by the user on the conference site picture, further comprises:
receiving a sliding track of a dragging operation performed by the user on the to-be-operated conference site picture on the target screen; and
rotating, according to the sliding track of the dragging operation, the multipicture division line that is used to form the border line of the display area for displaying the to-be-operated conference site picture.

9. The method for controlling multipicture display according to claim 1, wherein controlling picture display on the target screen according to the multipicture display mode formed using the multipicture division line that is obtained after the operation further comprises:
adjusting a to-be-displayed conference site picture according to an aspect ratio or a location of each display area in a formed multipicture display mode; and
displaying an adjusted conference site picture in the display area.

10. The method for controlling multipicture display according to claim 1, wherein controlling picture display on the target screen according to the multipicture display mode formed using the multipicture division line that is obtained after the operation further comprises:
retrieving a second multipicture display mode that is close to a first multipicture display mode from prestored multipicture display modes; and
controlling picture display on the target screen according to the second multipicture display mode, wherein the first multipicture display mode is the multipicture display mode formed using the multipicture division line that is obtained after the operation, and wherein the second multipicture display mode and the first multipicture display mode have the same number of display areas.

11. The method for controlling multipicture display according to claim 1, wherein controlling picture display on the target screen according to the multipicture display mode formed using the multipicture division line that is obtained after the operation further comprises:
retrieving a second multipicture display mode that is close to a first multipicture display mode from prestored multipicture display modes; and
controlling picture display on the target screen according to the second multipicture display mode, wherein the first multipicture display mode is the multipicture display mode formed using the multipicture division line that is obtained after the operation, and wherein an area difference between the second multipicture display mode and the first multipicture display mode is less than an area difference between any other multipicture display mode in the prestored multipicture display modes and the first multipicture display mode.

12. An apparatus for controlling multipicture display comprising:
a display;
a first processor; and
a second processor, wherein the first processor is separately connected to the display and the second processor, wherein the display is configured to receive a sliding track of a user operation and send the sliding track of the user operation to the first processor, wherein the first processor is configured to perform an operation on a multipicture division line according to the sliding track of the user operation and send the multipicture division line that is obtained after the operation to the second processor, and wherein the second processor is configured to control picture display on a target screen according to a multipicture display mode formed using the multipicture division line that is obtained after the operation.

13. The apparatus for controlling multipicture display according to claim 12, wherein the display comprises a first user interface configured to:
receive the sliding track of the operation performed by the user on a multipicture division line; and
send, to the first processor, the sliding track of the operation performed by the user on the multipicture division line, and wherein the first processor comprises a first processing module configured to perform the operation on the multipicture division line according to the sliding track of the operation performed by the user on the multipicture division line.

14. The apparatus for controlling multipicture display according to claim 13, wherein the first processing module comprises a first generating unit configured to receive, through the first user interface, the sliding track of the user from a first coordinate point to a second coordinate point, so as to generate the multipicture division line that uses the first coordinate point and the second coordinate point as endpoints.

15. The apparatus for controlling multipicture display according to claim 13, wherein the first processing module comprises a first adjusting unit configured to:
receive, through the first user interface, a selection operation, of the user, of selecting the multipicture division line;
determine a to-be-operated multipicture division line according to the selection operation;
receive, through the first user interface, the sliding track of the operation performed by the user on the to-be-operated multipicture division line; and
perform movement, rotation, or deletion on the to-be-operated multipicture division line, according to the sliding track of the operation performed by the user on the to-be-operated multipicture division line.

16. The apparatus for controlling multipicture display according to claim 12, wherein the display comprises a second user interface configured to:
receive the sliding track of the operation performed by the user on a conference site picture displayed on the target screen; and
send, to the first processor, the sliding track of the operation performed by the user on the conference site picture displayed on the target screen, and wherein the first processor comprises a second processing module configured to perform the operation on the multipicture division line according to the sliding track of the operation performed by the user on the conference site picture displayed on the target screen.

17. The apparatus for controlling multipicture display according to claim 16, wherein the second processing module comprises:
a second generating unit configured to:
receive, through the second user interface, the sliding track of dragging, by the user, the conference site picture into the target screen; and
generate the multipicture division line that is used to form a border line of a display area for displaying the conference site picture that is dragged according to the sliding track of dragging the conference site picture; and
a second adjusting unit configured to:
receive, through the second user interface, a selection operation, of the user, of selecting the conference site picture displayed on the target screen;
determine a to-be-operated conference site picture according to the selection operation;
receive, through the second user interface, the sliding track of the operation performed by the user on the conference site picture; and
perform movement, rotation, or deletion on the multipicture division line that is used to form the border line of the display area for displaying the to-be-operated conference site picture, according to the sliding track of the operation performed by the user on the conference site picture.

18. The apparatus for controlling multipicture display according to claim 17, wherein the second user interface is configured to:
receive the sliding track of a size adjusting operation performed by the user on the to-be-operated conference site picture; and
send, to the second adjusting unit, the sliding track of the size adjusting operation performed by the user on the to-be-operated conference site picture, and wherein the second adjusting unit is configured to move the multipicture division line that is used to form a border line of a display area for displaying the to-be-operated conference site picture, according to the sliding track of the size adjusting operation performed by the user on the to-be-operated conference site picture.

19. The apparatus for controlling multipicture display according to claim 12, wherein the second processor comprises:
a picture adjusting module configured to adjust a to-be-displayed conference site picture according to an aspect ratio and/or a location of each display area in a formed multipicture display mode; and
a first display control module configured to control an adjusted conference site picture to be displayed in the display area on the target screen.

20. A system for controlling multipicture display comprising:
a target screen; and
an apparatus for controlling multipicture display configured to:
receive a sliding track of a user operation;
perform an operation on a multipicture division line according to the sliding track of the user operation; and
control picture display on the target screen according to a multipicture display mode formed using the multipicture division line that is obtained after the operation, wherein the target screen is configured to display the picture.
